(19) United States
(12) Patent Application Publication
(10) Pub. No.: US 2011/0272611 A1
(43) Pub. Date: Nov. 10, 2011

(54) WATER VALVE BODY

(76) Inventor: Chung Shu HUANG, Taipei County (TW)

(21) Appl. No.: 12/878,754

(22) Filed: Sep. 9, 2010

(30) Foreign Application Priority Data
May 4, 2010 (TW) 099208233

(51) Int. Cl. F16K 31/02

(52) U.S. Cl. 251/129.15

(57) ABSTRACT

A water valve body includes a filter valve and a lower solenoid valve seat, both of which are integrally formed of plastic. The filter valve, as well as the lower solenoid valve seat, has an internal channel connecting an inlet end and an outlet end. The outlet end of the filter valve is connected to the inlet end of the lower solenoid valve seat, with a packing or a sealing element provided at the connecting position. In contrast to the conventional water valve body that is integrally formed of metal, this plastic-made water valve body is free of pollution associated with the leaching of heavy metals and incurs lower material cost. Besides, the plural components of the water valve body are selectively replaceable when damaged and thus also incur lower maintenance cost.

### BACKGROUND OF THE INVENTION

1. Technical Field

The present invention relates to water valve bodies and, more particularly, to a water valve body applicable to a sensor faucet or an automatic flusher, wherein the water valve body is assembled from multiple plastic components, produces no heavy metal pollution, and features low production cost as well as low replacement cost.

2. Description of Related Art

Water valves are widely used in a variety of fields to deliver water and control the quantity and direction thereof. Common examples of water valves are faucets in the kitchen or bathroom.

Water valves are available in many different configurations. For instance, the sensor faucet that is frequently used nowadays includes a faucet body above the countertop and a water valve body below the countertop and hence hidden from view. Typically, the water valve body is integrally formed by a process such as metal casting and is then connected with a filter device and a solenoid valve so as to release water automatically.

The aforesaid integrally formed and metal-made water valve body is advantageous in that it can be manufactured rapidly, has high strength, and is configured for convenient installation. However, if the metal of which the water valve body is made is of poor quality, there is a risk of heavy metal leaching, which not only causes water pollution but also endangers the water consumers' health. Another disadvantage of the integrally formed, metal-made water valve body is its high maintenance cost. This is because the water valve body does not allow partial replacement and must be replaced in its entirety once leakage occurs due to metal corrosion after long-term use. Moreover, the metal-made water valve body has a higher material cost and therefore a higher replacement cost than its plastic counterpart.

### BRIEF SUMMARY OF THE INVENTION

In view of the aforementioned shortcomings of the conventional water valve bodies that are integrally formed of metal, the present invention provides a water valve body that is assembled from of a plurality of components and hence allows partial replacement. Therefore, the cost of replacing the entire water valve body as required by an integrally formed water valve body when structurally damaged can be saved.

The water valve body according to the present invention has multiple plastic components. As plastic is less expensive than metal, the production cost and replacement cost of the water valve body are lower than those of a metal-made prior art device. If the plastic material used is highly stable and not prone to leaching, heavy metal pollution which is likely to result from metal-made water valve bodies can also be eliminated.

To achieve the above and other objects, the present invention provides a water valve body which includes a filter valve, a lower solenoid valve seat, and a packing. The filter valve is integrally formed of a plastic material and has an inlet end, a main valve body, and an outlet end. The inlet end of the filter valve is provided with a channel connected to the main valve body, and the main valve body is provided with a channel connected to the outlet end of the filter valve. The lower solenoid valve seat is integrally formed of a plastic material and has an inlet end, a valve seat body, and an outlet end. The inlet end of the solenoid valve seat is, on one hand, provided with a channel connected to the valve seat body and, on the other hand, connected to and in communication with the outlet end of the filter valve. Meanwhile, the valve seat body is provided with a channel connected to the outlet end of the lower solenoid valve seat. The packing has one side attached to the outlet end of the filter valve and the other side attached to the inlet end of the lower solenoid valve seat. In the water valve body, the inlet end of the filter valve and the outlet end of the lower solenoid valve seat are each connected with a threaded connecting pipe.

To use the water valve body described above, a filter device is installed on a top portion of the main valve body of the filter valve, and a solenoid valve is installed on a top portion of the lower solenoid valve seat. A fluid entering the filter valve via the connecting pipe thereof can flow into the interior of the filter device through the channels inside the filter valve. Then, the fluid passes through a channel of the packing, enters the channels of the lower solenoid valve seat, and is connected via the connecting pipe at the outlet end of the lower solenoid valve seat, either directly or by way of an additional pipe, to a water outlet device such as a faucet.

The water valve body of the present invention is constructed from multiple components and therefore allows partial replacement if some of the components are damaged. Compared with the conventional, integrally formed water valve bodies that must be replaced in their entirety, the water valve body of the present invention has advantageously lower initial cost and maintenance cost.

As the water valve body of the present invention is made of plastic, the risk of heavy metal leaching, which is likely with the conventional metal-made water valve bodies, can be eliminated by using a highly stable plastic material that is not prone to leaching.

Also, as the water valve body of the present invention is made of plastic, which has a lower material cost than metal, the initial cost and maintenance cost of the water valve body are effectively reduced.

The best mode of carrying out the present invention and the features of the disclosed subject matter are described hereinafter with reference to at least one embodiment of the present invention.

### BRIEF DESCRIPTION OF THE SEVERAL VIEWS OF THE DRAWINGS

FIG. 1 is an exploded perspective view of a water valve body according to a first preferred embodiment of the present invention;

FIG. 2 is an assembled perspective view of the water valve body shown in FIG. 1;

FIG. 3 is an assembled sectional view of the water valve body shown in FIG. 1;

FIG. 4 is a perspective view of the water valve body shown in FIG. 1 and further connected with a filter device and a solenoid valve;

FIG. 5 is a sectional view of FIG. 4;

FIG. 6 is an exploded perspective view of a water valve body according to a second preferred embodiment of the present invention;

FIG. 7 is an assembled perspective view of the water valve body shown in FIG. 6;

FIG. 8 is a perspective view of the water valve body shown in FIG. 6 and further connected with a filter device and a solenoid valve; and

FIG. 9 is a sectional view of FIG. 8.

### DETAILED DESCRIPTION OF THE INVENTION

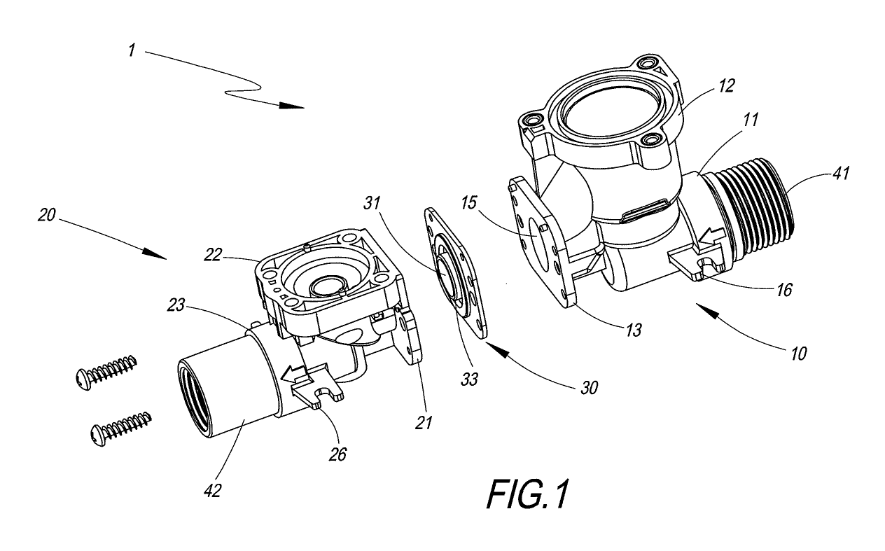

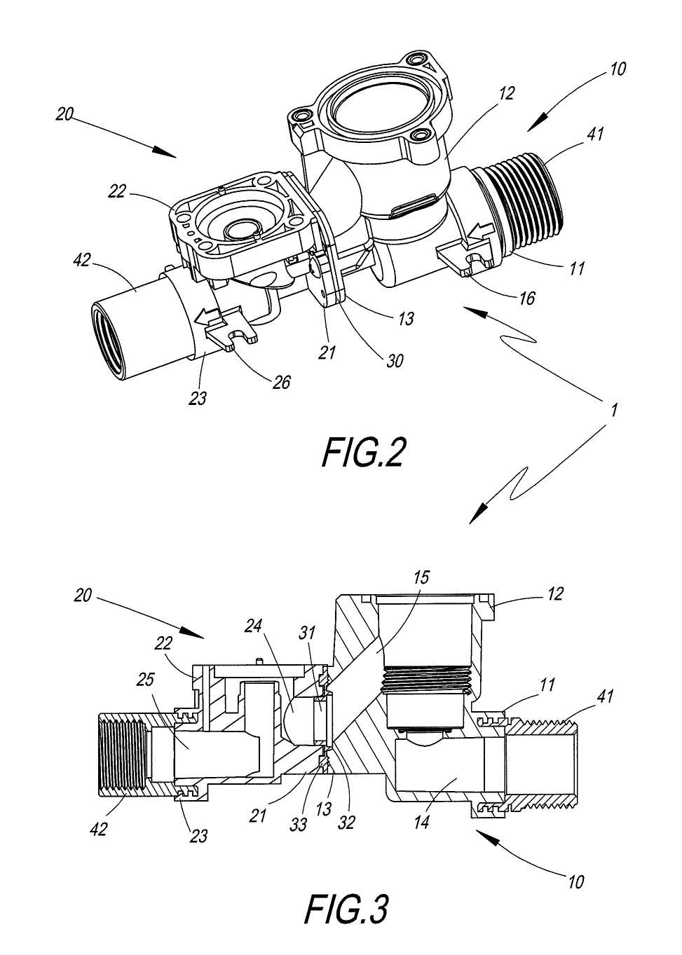

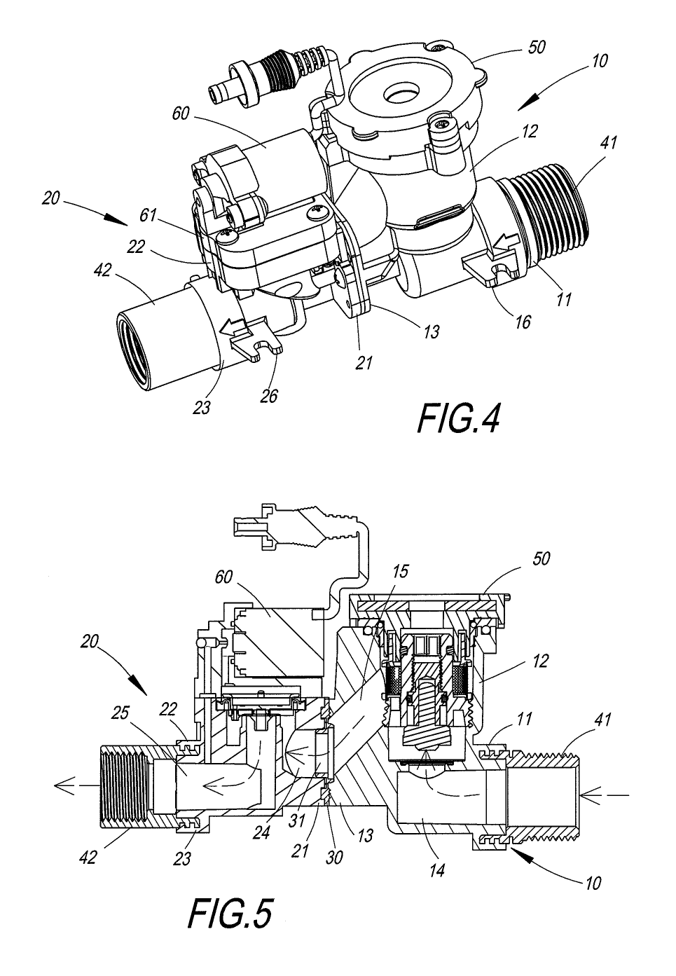

Referring to FIGS. 1 to 5, a water valve body 1 according to a first preferred embodiment of the present invention is applicable to the flusher of a urinal and includes a filter valve 10 and a lower solenoid valve seat 20. The filter valve 10 is integrally formed of a plastic material and has an inlet end 11, a main valve body 12, and an outlet end 13. The inlet end 11 is provided with a channel 14 connected to the main valve body 12. The main valve body 12 is provided with a channel 15 connected to the outlet end 13. The lower solenoid valve seat 20 is also integrally formed of a plastic material and has an inlet end 21, a valve seat body 22, and an outlet end 23. The inlet end 21 is provided with a channel 24 connected to the valve seat body 22. The valve seat body 22 is provided with a channel 25 connected to the outlet end 23.

In the water valve body 1, the outlet end 13 of the filter valve 10 is connected to the inlet end 21 of the lower solenoid valve seat 20. Thus, a fluid entering the water valve body 1 via the inlet end 11 of the filter valve 10 can flow through the channels 14, 15 in the filter valve 10, then enter the inlet end 21 of the lower solenoid valve seat 20, and after passing through the channels 24, 25 in the lower solenoid valve seat 20, flow out of the water valve body 1 via the outlet end 23 of the lower solenoid valve seat 20.

The water valve body 1 of the first preferred embodiment further includes a packing 30 tightly connected between the filter valve 10 and the lower solenoid valve seat 20. The packing 30 is formed with a transverse channel 31 through which a fluid can pass. When a fluid is delivered from the filter valve 10 to the lower solenoid valve seat 20, the packing 30 prevents the fluid from leaking. In the first preferred embodiment of the present invention, the two sides of the packing 30 are formed with flanges 32, 33 respectively. The flange 32 is fitted in the channel 15 at the outlet end 13 of the filter valve 10, and the flange 33 on the other side of the packing 30 is fitted in the channel 24 at the inlet end 21 of the lower solenoid valve seat 20, so as to enhance the anti-leakage function of the packing 30.

In the water valve body 1 of the first preferred embodiment, the inlet end 11 of the filter valve 10 and the outlet end 23 of the lower solenoid valve seat 20 are each connected with a threaded connecting pipe. More specifically, the inlet end 11 of the filter valve 10 is connected with an externally threaded pipe 41, and the outlet end 23 of the lower solenoid valve seat 20 is connected with an internally threaded pipe 42. The threaded pipes 41, 42 can be connected respectively to the filter valve 10 and the lower solenoid valve seat 20 after the filter valve 10 and the lower solenoid valve seat 20 are formed. However, in order to increase operational convenience and structural strength, the threaded pipes 41, 42 of the present invention are respectively and integrally connected to the filter valve 10 and the lower solenoid valve seat 20 by insert molding while the filter valve 10 and the lower solenoid valve seat 20 are formed.

To put the water valve body 1 of the first preferred embodiment into practical use, a filter device 50 is mounted on a top portion of the main valve body 12 of the filter valve 10, and a solenoid valve 60 (including an upper solenoid valve seat 61 at a bottom portion thereof) is mounted on a top portion of the lower solenoid valve seat 20. As indicated by the dashed line arrows in FIG. 5, a fluid enters the filter valve 10 via the connecting pipe 41 and subsequently enters the interior of the filter device 50 via the channel 14 in the filter valve 10. Then, the fluid flows sequentially through the channel 15, the channel 31 of the packing 30, and the channels 24, 25 of the lower solenoid valve seat 20. Finally, the fluid is connected to the flusher of a urinal (not shown) via the internally threaded pipe 42 at the outlet end 23 of the lower solenoid valve seat 20 either directly or by way of an additional pipe.

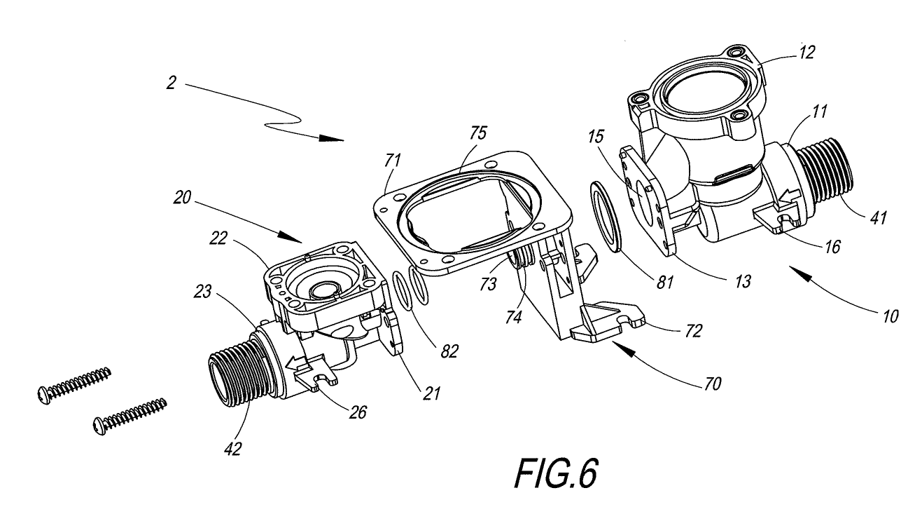

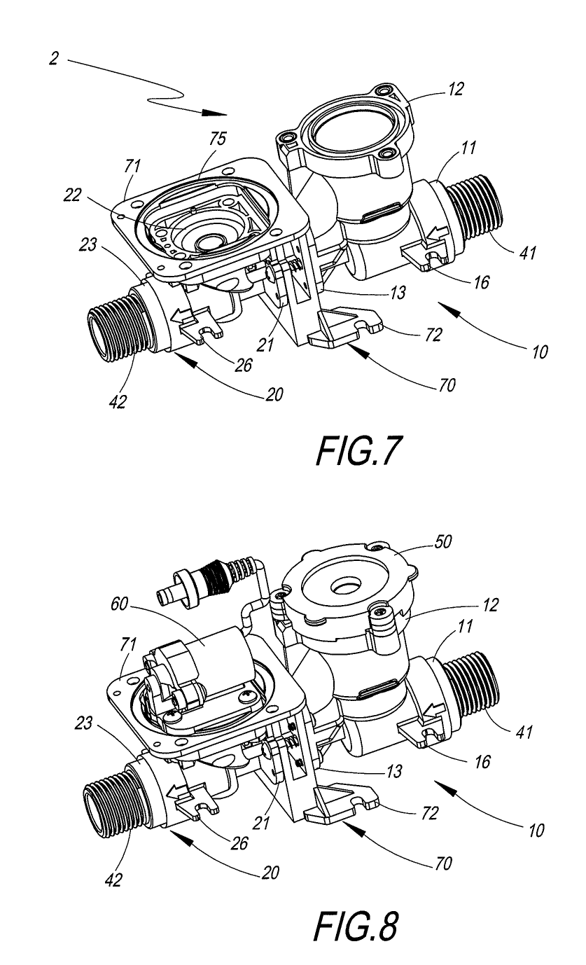

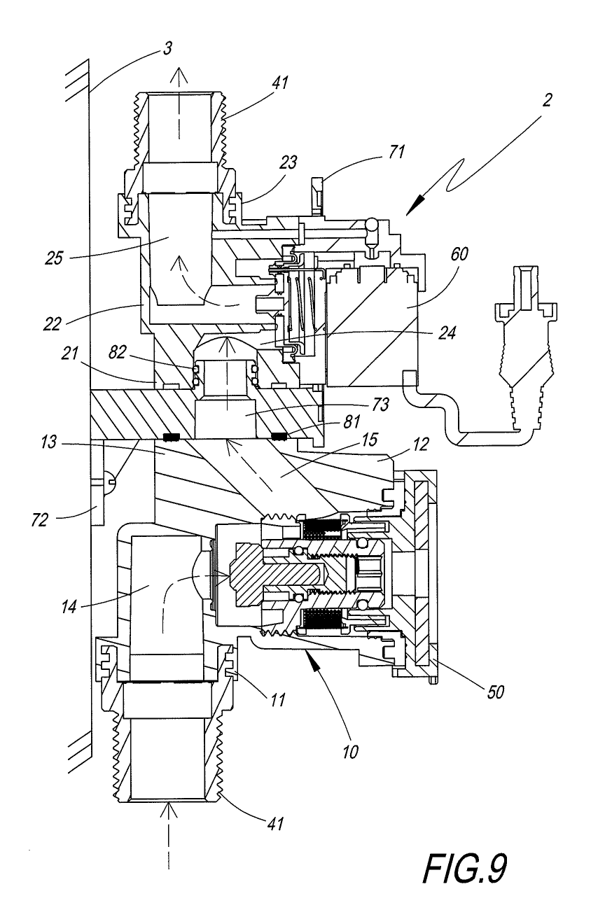

FIGS. 6 through 9 illustrate a water valve body 2 according to a second preferred embodiment of the present invention, wherein the water valve body 2 is for use with a faucet. In addition to the filter valve 10 and the lower solenoid valve seat 20 in the first preferred embodiment, the water valve body 2 includes a Z-shaped fixing plate 70 connected between the outlet end 13 of the filter valve 10 and the inlet end 21 of the lower solenoid valve seat 20. The Z-shaped fixing plate 70 has an upper portion formed with a battery installation plate 71, a lower portion formed with a pair of fixing feet 72, and a transverse channel 73 between the upper and lower portions. Once the Z-shaped fixing plate 70 is connected with the filter valve 10 and the lower solenoid valve seat 20, the transverse channel 73 of the Z-shaped fixing plate 70 is in communication with the outlet end 13 of the filter valve 10 and the inlet end 21 of the lower solenoid valve seat 20, thereby allowing a fluid to flow from the filter valve 10 to the lower solenoid valve seat 20, as shown in FIG. 9.

The packing used in the second preferred embodiment includes an annular pad 81 disposed between the Z-shaped fixing plate 70 and the outlet end 13 of the filter valve 10 and a pair of O-rings 82 located between the Z-shaped fixing plate 70 and the inlet end 21 of the lower solenoid valve seat 20. The annular pad 81 functions as a packing between the Z-shaped fixing plate 70 and the outlet end 13 of the filter valve 10. The O-rings 82 are mounted respectively around grooves 74 externally provided on the transverse channel 73 of the Z-shaped fixing plate 70 and are located between the grooves 74 and the inlet end 21 of the lower solenoid valve seat 20 (see FIG. 9), serving as sealing elements for leakage prevention.

The water valve body 2 of the second preferred embodiment is used in the same way as the first preferred embodiment. More specifically, a filter device 50 is mounted on the top portion of the main valve body 12 of the filter valve 10, and a solenoid valve 60 is mounted on the top portion of the lower solenoid valve seat 20 after passing through an opening 75 centrally provided on the battery installation plate 71 of the upper portion of the Z-shaped fixing plate 70. The battery installation plate 71 is configured for mounting a battery case (not shown).

As indicated by the dashed line arrows in FIG. 9, a fluid enters the filter valve 10 via the connecting pipe 41 and enters the interior of the filter device 50 via the channel 14 in the filter valve 10. After passing through the channel 15 and the transverse channel 73 of the Z-shaped fixing plate 70, the fluid enters the channels 24, 25 of the lower solenoid valve seat 20 sequentially and is connected to a faucet (not shown) via the internally threaded pipe 42 at the outlet end 23 of the lower solenoid valve seat 20 either directly or by way of an additional pipe.

In the water valve bodies 1, 2 according to the first and second preferred embodiments of the present invention, the filter valve 10 and the lower solenoid valve seat 20 are each provided with at least one installing and fixing means, such as the protrudingly provided fixing feet 16, 26 shown in the drawings. In addition, as the water valve body 2 of the second preferred embodiment is intended for use with a faucet, the pair of fixing feet 72 of the Z-shaped fixing plate 70 is configured for securing the water valve body 2 in position to a wall 3, as shown in FIG. 9.

The embodiments described above are only the preferred embodiments of the present invention and are not intended to limit the scope of the present invention. A person of ordinary skill in the art who has reviewed the technical contents disclosed herein may alter or modify the foregoing embodiments without departing from the spirit of the present invention. Therefore, the scope of the present invention is defined only by the appended claims.

What is claimed is:

1. A water valve body, comprising:
a filter valve having an inlet end, a main valve body, and an outlet end which are integrally formed of plastic, the inlet end of the filter valve being provided with a channel connected to the main valve body, the main valve body being provided with a channel connected to the outlet end of the filter valve;
a lower solenoid valve seat having an inlet end, a valve seat body, and an outlet end which are integrally formed of plastic, the inlet end of the lower solenoid valve seat being provided with a channel connected to the valve seat body, the valve seat body being provided with a channel connected to the outlet end of the lower solenoid valve seat, wherein the inlet end of the solenoid valve seat is connected to and in communication with the outlet end of the filter valve; and
at least a packing having a side attached to the outlet end of the filter valve and an opposite side attached to the inlet end of the lower solenoid valve seat.

2. The water valve body of claim 1, wherein each of the inlet end of the filter valve and the outlet end of the lower solenoid valve seat is connected with a threaded connecting pipe.

3. The water valve body of claim 2, wherein the connecting pipes are connected respectively with the inlet end of the filter valve and the outlet end of the lower solenoid valve seat by insert molding.

4. The water valve body of claim 1, further comprising a Z-shaped fixing plate connected between the outlet end of the filter valve and the inlet end of the lower solenoid valve seat, wherein the at least a packing is provided between the Z-shaped fixing plate and the outlet end of the filter valve and between the Z-shaped fixing plate and the inlet end of the lower solenoid valve seat, respectively.

5. The water valve body of claim 4, wherein the Z-shaped fixing plate has an upper portion formed with a battery installation plate, a lower portion formed with a pair of fixing feet, and a transverse channel between the upper portion and the lower portion, the transverse channel being in communication with the outlet end of the filter valve and the inlet end of the lower solenoid valve seat.

6. The water valve body of claim 1, wherein each of the filter valve and the lower solenoid valve seat is protrudingly provided with at least a fixing foot.
